(19) United States
(12) Patent Application Publication
(10) Pub. No.: US 2021/0004808 A1
(43) Pub. Date: Jan. 7, 2021

(54) DIGITAL APPLICATION INSTRUMENT INSTANTIATION

(71) Applicant: GOOGLE LLC, Mountain View, CA (US)

(72) Inventors: Vishu Goyal, Mountain View, CA (US); Diana Ioana Nistor, Los Altos, CA (US)

(21) Appl. No.: 16/503,936

(22) Filed: Jul. 5, 2019

(51) Int. Cl. G06Q 20/40; G06N 20/00

(52) U.S. Cl. CPC G06Q 20/4016; G06N 20/00

(57) ABSTRACT

Adding an instrument to a digital application comprises a processor for training a machine-learning process based on historic data related to interactions of an instrument with counter-parties and users. The processor receives a request to add the instrument to a digital application associated with a user and accesses data associated with the instrument, the user, and the digital application. The processor enters the accessed data into the machine-learning process and determines a risk score of adding the instrument to the digital application based on the machine-learning process. If the processor determines that the risk score is less than or equal to a configured threshold, the processor adds the instrument to the digital application. If the risk score is greater than the threshold, the processor rejects the addition of the instrument.

### TECHNICAL FIELD

The present disclosure relates to installing instruments on digital applications. More specifically, a machine-learning algorithm is trained and used to determine if the installation of the instrument has a risk likelihood greater than a threshold at time of instantiation on the digital instrument.

### BACKGROUND

In conventional systems, processing systems evaluate interactions at a time of use to determine if the interaction has a high risk. Interactions that are considered to have an elevated risk, may be rejected or sent for further evaluation. When interactions are rejected, the interaction may be delayed or terminated while a suitable instrument or alternate interaction is identified at the point of sale. When interactions are delayed or terminated, users and interaction counter-parties become frustrated and discouraged and may not complete the interaction.

### SUMMARY

Techniques herein provide computer-implemented methods to add instruments to digital applications at a time that is before a time of a pending interaction. The methods include training a machine-learning process based on historic data related to interactions of an instrument with counter-parties and users. The processor receives a request to add the instrument to a digital application associated with a user and accesses data associated with the instrument, the user, and the digital application. The processor enters the accessed data into the machine-learning process and determines a risk score of adding the instrument to the digital application based on the machine-learning process. If the processor determines that the risk score is lower than or equal to a configured threshold, the processor adds the instrument to the digital application. If the risk score is higher than the threshold, the processor rejects the addition of the instrument.

In certain other example aspects described herein, systems and computer program products to add instruments to digital applications are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to add an instrument to a digital application, in accordance with certain examples.

FIG. 2 is a block flow diagram depicting a method to add an instrument to a digital application, in accordance with certain examples.

FIG. 3 is a block flow diagram depicting a method to analyze the instrument via a machine-learning algorithm, in accordance with certain examples.

FIG. 4 is a block diagram depicting a computing machine and a module, in accordance with certain examples.

### DETAILED DESCRIPTION

### Overview

In certain examples, a machine-learning algorithm, processor, software, or other machine-learning system is trained and utilized to analyze an instrument to determine if the instrument should be added to a digital application. If the instrument is determined to pose a risk of fraud or otherwise determined not to be a suitable instrument based on recognized factors and characteristics, then the digital application will reject the instrument. That is, the instrument is not added to the digital application at all when the risk score is elevated. If the instrument is a suitable instrument based on the circumstances and accessed history, then the digital application incorporates the instrument and allows the user to access the instrument at a subsequent interaction.

In an example, the instrument is a payment instrument or an access instrument, such as a credit card, debit card, store card, prepaid card, loyalty card, identification card, or any other suitable instrument. In an example, the digital application is a digital wallet or similar application that the user employs to manage payment instruments and other instruments. The digital wallet allows the user to make rules for deciding which instrument to use for different interactions. The digital wallet may perform any other algorithm or selection process when a payment instrument is requested. In an example, the interaction is a payment transaction, but other types of interactions may be used, such as a check-in, an access authorization, a ticket display, or any other suitable interaction.

In certain examples described herein, the instrument will be described as a payment instrument, a digital application as a digital wallet, and an interaction as a transaction. These examples are used for illustrative purposes.

A digital wallet system or other system manages the digital wallet. The digital wallet system trains a machine-learning processor with data about credit card (or other instrument) reliability, fraud, reputations, ease of use, and other suitable factors. In an example, the machine-learning processor is a supervised machine-learning processor, such as a Gradient Boosting Decision Tree (“GBDT”). Other machine-learning processors could be used in alternative examples. GBDT is used in examples herein to represent the machine-learning processor, algorithm, or other machine-learning hardware or software.

The GBDT is trained based on data from instrument issuers, card networks, digital wallet applications, user histories, merchant data, or any other suitable data that may help quantify and characterize instruments and instrument issuers. In a supervised learning environment, operators provide the GBDT with training data containing input/predictors related to the issuers and then provide the GBDT with preferred conclusions based on the data. The GBDT is able to recognize and learn the patterns from the data input. An alternate machine-learning technique or algorithm may analyze unsupervised data to search for rules, detect patterns, and summarize and group the data associated with the instrument. Any suitable machine-learning process, algorithm, or system may be used to learn about the data.

When a digital wallet receives a request to add an instrument to the digital wallet, the digital wallet determines the issuer of the instrument, such as a credit card issuer. The digital wallet communicates data associated with the request to the digital wallet system or any system that is hosting the GBDT.

The GBDT receives data that includes user history with the instrument, user history with other instruments, history of the issuer of the instrument, merchant interactions with the instrument, the type of user computing device operating the digital wallet, chargebacks associated with the issuer, signals from other banks and payment processing systems, and any other suitable data. The data is entered into the GBDT to allow the GBDT to learn about the instrument to enable more accurate assessments for the performance of the instrument.

For example, the GBDT determines an overall risk level of the instrument. That is, the GBDT determines if the instrument is likely to be fraudulent, involved in an excessive number of chargebacks, difficult to use, slow to pay invoices, or in any other way that a risk is associated with the instrument. A risk threshold is determined by the user, the digital wallet system, the digital wallet, a payment processing system, or any suitable party that desires to reduce fraudulent transactions.

If the risk is above the threshold, then the digital wallet does not add the payment instrument. If the risk is less than or equal to the threshold, the digital wallet adds the payment instrument. The payment instrument is available for use to the user at the next interaction, such as a subsequent transaction at a merchant system.

By using and relying on the methods and systems described herein, the digital wallet system is able to better protect the user and merchants from fraud, misuse, and payment delays. When systems and methods determine whether to approve or disapprove a payment instrument at the time of a transaction, each party to the transaction is delayed or turned away. A rejected transaction may cause frustration or embarrassment to the user or the merchant, and may prevent completion of the transaction. By performing the risk analysis at the time of adding the instrument to the digital wallet, the decision is made before the time of transaction. If an instrument is rejected, then the user has time to add a different card/instrument before a transaction is initiated. Using machine-learning to perform the risk analysis allows more data to be processed and greater insights into the risk of the instrument to be learned than an analysis by a person or typical database would allow. The machine-learning will become more and more proficient at evaluating instrument risks as more data is acquired.

### Example System Architectures

Turning now to the drawings, in which like numerals represent like (but not necessarily identical) elements throughout the figures, example embodiments are described in detail.

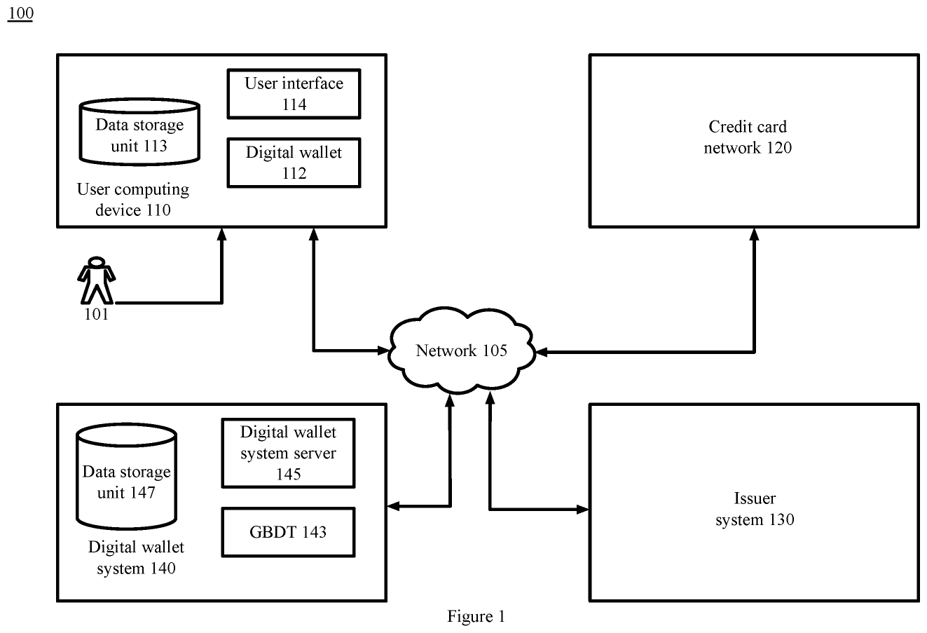

FIG. 1 is a block diagram depicting a system 100 to add an instrument to a digital wallet 112. In some embodiments, a user 101 associated with a user computing device 110 must install an application and/or make a feature selection to obtain the benefits of the techniques described herein.

As depicted in FIG. 1, the system 100 includes network computing devices/systems 110, 120, 130, and 140 that are configured to communicate with one another via one or more networks 105 or via any suitable communication technology.

Each network 105 includes a wired or wireless telecommunication means by which network devices (including devices 110, 120, 130, and 140) can exchange data. For example, each network 105 can include a local area network (“LAN”), a wide area network (“WAN”), an intranet, an Internet, a mobile telephone network, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data. Throughout the discussion of example embodiments, it should be understood that the terms “data” and “information” are used interchangeably herein to refer to text, images, audio, video, or any other form of information that can exist in a computer-based environment. The communication technology utilized by the devices 110, 120, 130, and 140 may be similar networks to network 105 or an alternative communication technology.

Each network computing device/system 110, 120, 130, and 140 includes a computing device having a communication module capable of transmitting and receiving data over the network 105 or a similar network. For example, each network device 110, 120, 130, and 140 can include a server, desktop computer, laptop computer, tablet computer, a television with one or more processors embedded therein and/or coupled thereto, smart phone, handheld or wearable computer, personal digital assistant (“PDA”), wearable devices such as smart watches or glasses, or any other wired or wireless, processor-driven device. In the example embodiment depicted in FIG. 1, the network devices 110, 120, 130, and 140 are operated by end-users or consumers, credit card network operators, issuer system operators, and digital wallet system operators, respectively.

The user computing device 110 includes a user interface 114. The user interface 114 may be used to display a graphical user interface and other information to the user 101 to allow the user 101 to interact with the digital wallet system 140 and others. The user interface 114 receives user input for displaying a digital wallet 112 and other applications.

The user computing device 110 also includes a data storage unit 113 accessible by a communication application (not shown) and one or more applications, such as the digital wallet application 112. The example data storage unit 113 can include one or more tangible computer-readable storage devices. The data storage unit 113 can be stored on the user computing device 110 or can be logically coupled to the user computing device 110. For example, the data storage unit 113 can include on-board flash memory and/or one or more removable memory accounts or removable flash memory. In certain embodiments, the data storage unit 113 may reside in a cloud based computing system.

The digital wallet application 112 may encompass any application, hardware, software, or process the user computing device 110 may employ to assist the user 101 in completing a purchase transaction or other interaction. The digital wallet 112 can interact with a communication application, such as a web browser, or can be embodied as a companion application of a communication application. The digital wallet 112 may be provided to the user computing device 110 by the digital wallet system 140 or otherwise associated with the digital wallet system 140. The digital wallet system 140 may manage the operations, updates, and other functions of the digital wallet 112.

An example digital wallet system 140 comprises a digital wallet system server 145, a data storage unit 147, and a machine-learning computing system, such as a Gradient Boosting Decision Tree (“GBDT”) 143.

In an example embodiment, the digital wallet system server 145 communicates with the credit card network 120, the issuer system 130, the user computing device 110, or other systems over network 105 to request and receive data related to card instruments, transactions, interactions, and other suitable data. The digital wallet system 140 may provide downloads of the digital wallet 112 for user computing devices 110 or others. The digital wallet system 140 may provide data in real-time to payment processing systems (not pictured) or the credit card network 120 to facilitate transactions.

In an example embodiment, the data storage unit 147 can include any local or remote data storage structure accessible to the digital wallet system 140 suitable for storing information. In an example embodiment, the data storage unit 147 stores encrypted information.

The GBDT 143 represents any type of neural network computing system or other computing system that employs any machine-learning process or algorithm. The GBDT 143 is able to receive data from many varied sources and use the data to interpret patterns and characterize features of users 101, instruments, issuers systems 130, and others involved in the transaction process. The GBDT 143 is able to continually or periodically update the received information in a manner that allows the data presented by the digital wallet system 140 to become more useful and accurate as more data is received and stored. The GBDT 143 may be a function or computing device of the digital wallet system 140 that is used by the digital wallet system 140 to perform some or all of the functions herein that are described as being performed by the digital wallet system 140 or the digital wallet system server 145.

Alternatively, the GBDT 143 may be hosted by a third party system, the digital wallet 112, or any other suitable host. The GBDT 143 represents an example of a machine-learning process or algorithm. Any other suitable process may be used, such as a different supervised learning process, an unsupervised learning process, or reinforcement learning.

A credit card network 120 represents any suitable card network utilized for conducting transactions. A credit card network system 120 facilitates transactions between merchants and issuer systems 120. In an example, the credit card network 130 decides where credit cards can be accepted, approves transactions, and facilitates payments.

A card issuer system 130 may be a bank or other institution that issues instruments, such as credit cards, debit cards, prepaid cards, and other instruments. In an example, the issuer 130 approves credit card applications, sets terms for user, issues the physical and digital cards, and provides funds for transactions.

It will be appreciated that the network connections shown are examples and other means of establishing a communications link between the computers and devices can be used. Moreover, those having ordinary skill in the art having the benefit of the present disclosure will appreciate that the card issuer system 130, the credit card network 130, digital wallet system 140, and the user computing device 110 illustrated in FIG. 1 can have any of several other suitable computer system configurations. For example, a user computing device 110 can be embodied as a mobile phone or handheld computer, and may not include all the components described above.

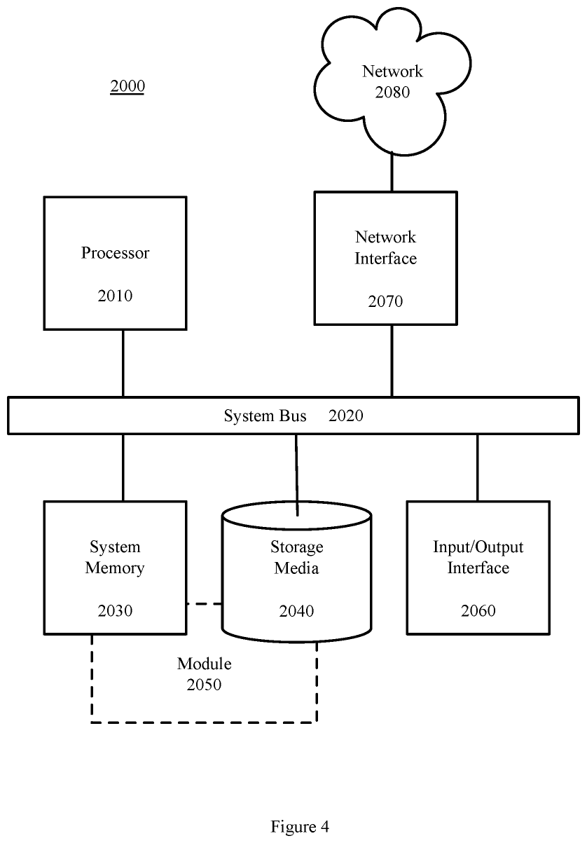

In example embodiments, the network computing devices and any other computing machines associated with the technology presented herein may be any type of computing machine such as, but not limited to, those discussed in more detail with respect to FIG. 4. Furthermore, any functions, applications, or components associated with any of these computing machines, such as those described herein or any others (for example, scripts, web content, software, firmware, hardware, or modules) associated with the technology presented herein, may by any of the components discussed in more detail with respect to FIG. 4. The computing machines discussed herein may communicate with one another, as well as with other computing machines or communication systems over one or more networks, such as network 105. The network 105 may include any type of data or communications network, including any of the network technology discussed with respect to FIG. 4.

### Example Processes

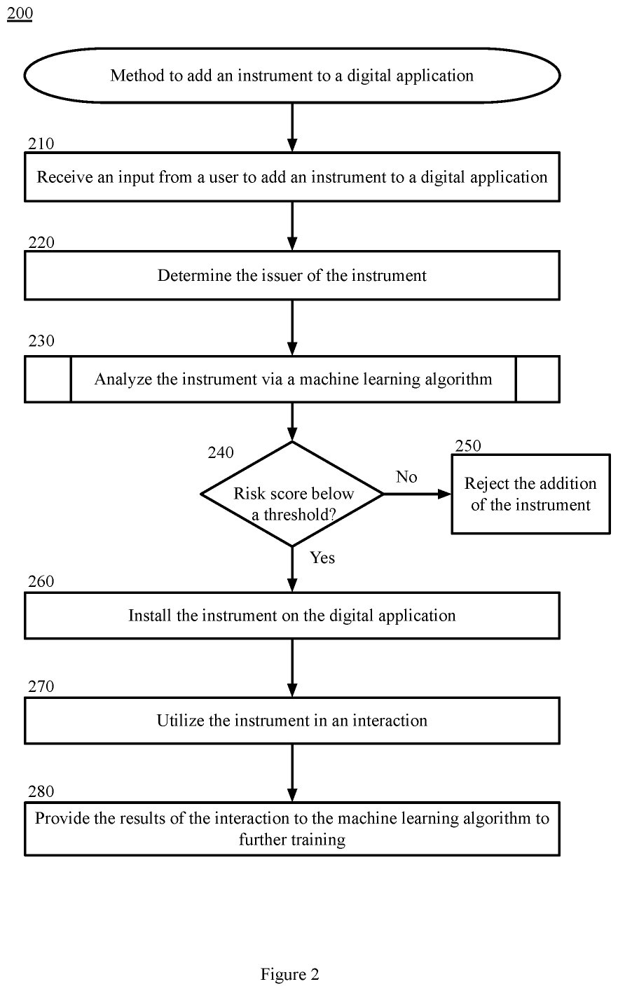

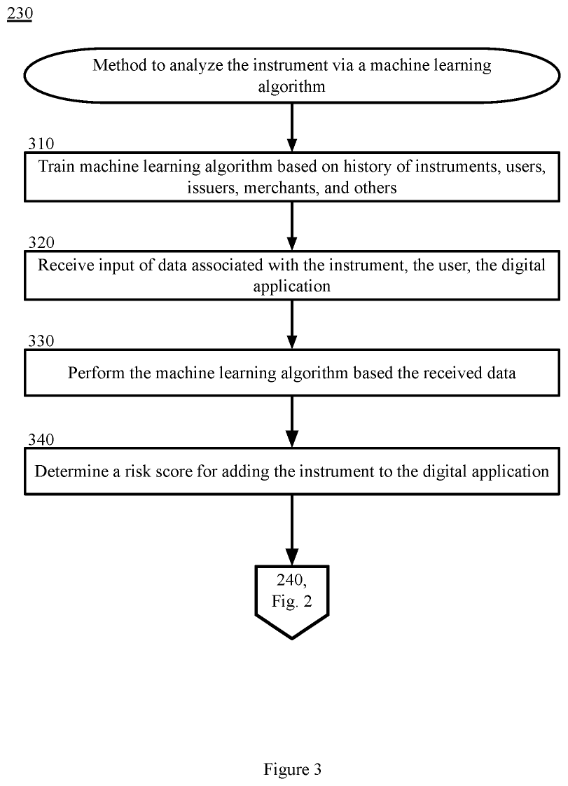

The example methods illustrated in FIGS. 2-3 are described hereinafter with respect to the components of the example operating environment 100. The example methods of FIGS. 2-3 may also be performed with other systems and in other environments. The operations described with respect to any of the FIGS. 2-3 can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

FIG. 2 is a block flow diagram depicting a method 200 to add an instrument to a digital application, in accordance with certain example embodiments.

In block 210, a digital wallet 112 and/or a digital wallet system 140 receives an input from a user 101 to add an instrument to a digital application. In the example, the digital application is illustrated by the functions of a digital wallet 112. The functions of the digital wallet 112 may be performed by the digital wallet 112 on the user computing device 110 or by one or more computing devices on the digital wallet system 140. That is, the digital wallet 112 may communicate freely with the digital wallet system 140 over an Internet connection or other connection and perform the tasks jointly or alternately. Tasks described herein as being performed by the digital wallet 112 or the digital wallet system 140 may alternatively be performed by either.

In an example, the user 101 enters a command to add the instrument to the digital wallet 112 via the user interface 114 of the user computing device 110. The user 101 may drag an icon of the instrument into an icon of the digital wallet 112. The user 101 may speak a voice command to add the instrument. The user 101 may select an item from a list to add the instrument. The user 101 may perform any suitable action to initiate the addition of the instrument to the digital wallet 112.

In another example, a different party attempts to add the instrument to the digital wallet 112. The issuer system 130 may attempt to add the instrument. The digital wallet system 112 may attempt to add the instrument. Any suitable party may initiate the process to add the instrument to the digital wallet 112.

In block 220, the digital wallet 112 identifies the issuer system 130 of the instrument. In an example, the digital wallet 112 analyzes the instrument identification number, metadata associated with the instrument, collateral data associated with the instrument, or any other suitable data for identifying the issuer system 130. In another example, the user 101 inputs the identity of the issuer system 130. Any suitable manner of determining the issuer system 130 of the instrument may be used.

In block 230, the digital wallet system 140 analyzes the instrument via a machine-learning algorithm. The details of block 230 are described in greater detail with respect to method 230 of FIG. 3.

FIG. 3 is a block flow diagram depicting a method to analyze the instrument via a machine-learning algorithm, in accordance with certain examples.

In block 310, the digital wallet system 140 trains a machine-learning algorithm, program, model, processor, or other machine-learning process based on a history of instruments, users, issuers, merchants, and any other suitable party. The digital wallet system 140 trains the machine-learning processor or algorithm with data about credit card reliability, fraud, chargebacks, reputations, ease of use, and other suitable factors. In an example, the machine-learning processor is a supervised machine-learning processor, such as a Gradient Boosting Decision Tree (“GBDT”) 143. Other machine-learning processors could be used in alternative examples. GBDT 143 is used in examples herein to represent the machine-learning processor, algorithm, or other machine-learning hardware or software. The GBDT 143 may be hosted by a third party system, the digital wallet 112, or any other suitable host. The GBDT 143 represents an example of a machine-learning process or algorithm. Any other suitable process may be used, such as a different supervised learning process, an unsupervised learning process, or reinforcement learning.

The GBDT 143 represents any type of neural network computing system or other computing system that employs any machine-learning process or algorithm. The GBDT 143 is able to receive data from many varied sources and use the data to interpret patterns and characterize features of users 101, instruments, issuer systems 130, and others involved in the transaction process. The GBDT 143 is able to continually or periodically update the received information in a manner that allows the data presented by the digital wallet system 140 to become more useful as more data is received and stored. The GBDT 143 may be a function or computing device of the digital wallet system 140 that is used by the digital wallet system 140 to perform some or all of the functions herein that are described as being performed by the digital wallet system 140 or the digital wallet system server 145.

The GBDT 143 is trained based on data from issuer systems 130, credit card networks 120, digital wallet applications 112, user histories, merchant data, or any other suitable data that may help quantify and characterize instruments and instrument issuers 130. In a supervised learning environment, operators provide the GBDT 143 with training data containing input/predictors related to the issuers and then provide the GBDT 143 with preferred conclusions based on the data. The GBDT 143 is able to recognize and learn the patterns from the data input. An alternate machine-learning technique or algorithm may analyze unsupervised data to search for rules, detect patterns, and summarize and group the data associated with the instrument. Any suitable machine-learning process, algorithm, or system may be used to learn about the data.

In block 320, the digital wallet system 140 receives an input of data associated with the instrument, the user 101, and the digital wallet 112. The digital wallet system 140 inputs, into the GBDT 143, data that includes user history with the instrument, user history with other instruments, history of the issuer 130 of the instrument, merchant interactions with the instrument, the type of user computing device 110 operating the digital wallet 112, chargebacks associated with the issuer 130, signals from other banks and payment processing systems, and any other suitable data. The data is entered into the GBDT 143 to allow the GBDT 143 to learn about the instrument to enable more accurate assessments for the performance of the instrument.

In block 330, the GBDT 143 performs the machine-learning algorithm based on the received data. Based on the model, algorithm, decision tree, or other system used by the GBDT 143 to predict outcomes of new instruments, the GBDT 143 analyzes the proposed instrument.

In block 340, the GBDT 143 determines a risk score for adding the instrument to the digital wallet 112. The risk score measures the likelihood that the instrument will be used fraudulently, will likely encounter a high number of chargebacks, will be used recklessly, will be rejected by merchants more frequently than is standard, will be difficult to use, will be slow to pay invoices, or will likely pose any other risk. The risk score may be configured to any suitable scale, such as a 0-100 score, a letter grade, a poor-to-great Likert scale, or any other suitable risk score scale.

A risk threshold is determined by the user, the digital wallet system 140, the digital wallet 112, a payment processing system, or any suitable party that desires to reduce fraudulent transactions. If the risk score is, for example, based on a 1-100 scale, the threshold may be set at a suitable number, such as 70.

From block 340, the method 230 returns to block 240 of FIG. 2.

Returning to FIG. 2, in block 240, the digital wallet system 140 determines if the risk score is greater than or less than a threshold. For example, if the scale is 0-100, the threshold is 70, and the risk score is 80, then the risk score is over the threshold. If the risk score is not below the threshold, then the method 230 follows the NO path to block 250.

In block 250, if the risk score is not less than the threshold, then the digital wallet system 140 rejects the addition of the instrument. The digital wallet 112 provides a notification to the user 101 that the instrument is not being added to the digital wallet 112. The user 101 may attempt the addition at a later time, select an alternate instrument, or perform any other suitable action in response to the notification.

If the risk score is less than the threshold, then the method 230 follows the YES path to block 260.

In block 260, if the risk score is below (or equal to) the threshold, then the digital wallet system 140 installs the instrument on the digital wallet 112. The instrument is available for use to the user 101 at the next interaction, such as a subsequent transaction at a merchant system. The instrument details are stored in the digital wallet 112 such that at the time of a transaction, the digital wallet 112 is able to present the instrument for use in the transaction.

In block 270, the user 101 utilizes the instrument in an interaction. For example, the user 101 presents an item for purchase at a merchant location. The user 101 selects or otherwise indicates that that the digital wallet 112 is to use the instrument for the transaction. The digital wallet 112 accesses the details of the instrument and presents the data to the merchant system.

In block 280, the digital wallet system 140 provides the results of the interaction to the machine-learning algorithm for further training. Based on continuous or periodic updating of transactions of the user 101 and the instrument, the GBDT 143 is able to improve the models or algorithms for future risk scores. When a subsequent user 101 attempts to add a similar instrument to a digital wallet 112, the GBDT 143 is able to more accurately predict the risk due to the additional training materials.

### Example Systems

FIG. 4 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a wearable computer, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read-only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCP”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to add instruments to digital applications, comprising:
by one or more computing devices:
receiving a request to add an instrument to a digital application associated with a user;
accessing data associated with the instrument and the user;
determining a risk of adding the instrument to the digital application;
determining that the risk is less than a configured threshold; and
adding the instrument to the digital application.

2. The computer-implemented method of claim 1, further comprising:
training a machine-learning process based on historic data related to interactions of an instrument with counter-parties and users.

3. The computer-implemented method of claim 2, further comprising:
entering the accessed data into the machine-learning process.

4. The computer-implemented method of claim 3, wherein the determination of the risk is based on an output of the machine-learning process.

5. The computer-implemented method of claim 4, further comprising providing results of subsequent interactions of the instrument to the machine-learning process to further train the machine-learning process.

6. The computer-implemented method of claim 1, further comprising:
receiving a request to add a second instrument to the digital application associated with a user;
accessing data associated with the instrument and the user;
determining a risk of adding the second instrument to the digital application;
determining that the risk is greater than the configured threshold; and
declining to add the second instrument to the digital application.

7. The computer-implemented method of claim 1, further comprising:
determining that the risk is equal to a configured threshold; and
adding the instrument to the digital application.

8. The computer-implemented method of claim 1, wherein accessing data associated with the instrument comprises accessing data associated with the digital application.

9. The computer-implemented method of claim 1, wherein the threshold is configured by one or more of the user, the digital application, an issuer of the instrument, and a card network associated with the instrument.

10. The computer-implemented method of claim 1, further comprising utilizing, by the digital application, the instrument in a subsequent interaction with a counter-party.

11. The computer-implemented method of claim 1, wherein a higher risk is an indication that the instrument has a higher likelihood of being fraudulent.

12. The computer-implemented method of claim 1, wherein a lower score is an indication that the instrument has a lower likelihood of being fraudulent.

13. The computer-implemented method of claim 1, wherein the digital application is a digital wallet application.

14. The computer-implemented method of claim 1, wherein the instrument is a credit card, a debit card, or an access card.

15. The computer-implemented method of claim 1, wherein the machine-learning process is a supervised machine-learning model.

16. The computer-implemented method of claim 1, wherein the machine-learning process is a gradient boosting decision tree.

17. The computer-implemented method of claim 1, wherein the machine-learning process is an unsupervised machine-learning model.

18. A computer program product, comprising:
a non-transitory computer-readable storage device having computer-executable program instructions embodied thereon that when executed by a computer cause the computer to add instruments to digital applications, the computer-executable program instructions comprising computer-executable program instructions to:
train a machine-learning process based on historic data related to interactions of a payment instrument with counter-parties and users;
receive a request to add the payment instrument to a digital wallet associated with a user;
access data associated with the instrument and the user;
determine a risk score of adding the payment instrument to the digital wallet based on the machine-learning process;
determine that the risk score is less than or equal to a configured threshold; and
add the payment instrument to the digital wallet.

19. The computer program product of claim 18, further comprising computer-executable program instructions to:
receive a request to add a second instrument to the digital application associated with a user;
access data associated with the instrument and the user;
determine a risk of adding the second instrument to the digital application;
determine that the risk is greater than the configured threshold; and
decline to add the second instrument to the digital application.

20. A system to add instruments to digital applications, comprising:
a storage device;
a network device; and
a processor communicatively coupled to the storage device and the network device, wherein the processor executes application code instructions that are stored in the storage device to cause the system to:
receive a request to add an instrument to a digital application associated with a user;
access data associated with the instrument and the user;
determine a risk of adding the instrument to the digital application based on an output of a machine-learning process;
determine that the risk is less than a configured threshold; and
add the instrument to the digital application.
